(19) United States
(12) Patent Application Publication
(10) Pub. No.: US 2021/0081968 A1
(43) Pub. Date: Mar. 18, 2021

(54) SYSTEMS AND METHODS FOR PREDICTING AND RESOLVING SURGE PERIODS

(71) Applicant: Talkdesk, Inc, San Franciss, CA (US)

(72) Inventors: Jason Fama, San Carlos, CA (US); Patrick Russell, Columbus, OH (US); Richard Lawrence, San Diego, CA (US)

(21) Appl. No.: 16/573,040

(22) Filed: Sep. 17, 2019

(51) Int. Cl. G06Q 30/02; G06Q 10/10; G06Q 10/06

(52) U.S. Cl. CPC G06Q 30/0202; G06Q 30/0201; G06Q 10/06312; G06Q 10/06393; G06Q 10/1097

(57) ABSTRACT

A surge engine is provided that predicts upcoming surges for a business such as a contact center or a retail environment. The surge engine may receive a schedule for the business that indicates one or more employees or agents that are scheduled to work for each period. The surge engine further receives a customer or workload forecast for each period that is based on historical customer and workload data for the business. The surge engine then predicts a surge for an upcoming period based on the workload forecast for that period and the schedule for that period. The surge engine may further consider real-time data about the busyness of the business when predicting surges. For each predicted surge, the surge engine automatically identifies employees or agents who may be available to work during the predicted surge, and offers them one or more incentives to work during the predicted surge.

### BACKGROUND

No matter how well prepared a business is, spikes in customer volume are going to occur. Such spikes in customer volume are referred to herein as “surges”. For example, a supermarket may experience a surge of shoppers that may overwhelm the number of cashiers that are available. In another example, a call enter may experience a surge in customer calls, which may overwhelm the number of agents that are available to handle the calls. Surges, if not properly handled, often result in poor customer service levels, dissatisfied customers, and missed opportunities for the business or retailer.

Accordingly, there is a need to predict surges in customer volume, and to mitigate the negative effects associated with surges.

### SUMMARY

A surge engine is provided that predicts upcoming surges for a business such as a contact center or a retail environment. The surge engine may receive a schedule for the business that indicates one or more employees or agents that are scheduled to work for each period. The surge engine further receives a customer or workload forecast for each period that is based on historical customer and workload data for the business. The surge engine then predicts a surge for an upcoming period based on the workload forecast for that period and the schedule for that period. The surge engine may further consider real-time data about the busyness of the business when predicting surges. For each predicted surge, the surge engine automatically identifies employees or agents who may be available to work during the predicted surge and that have the necessary skills, and offers them one or more incentives to work during the predicted surge. The surge engine may further identify agents and employees who have meetings, appointments, or breaks scheduled during the predicted surge, and may ask the identified agents and employees to reschedule so that they can work during the predicted surge.

After one or more surges have passed, the surge engine may calculate a surge score for each agent or employee that is based on points earned by the agents or employees for working during the surge periods. The points earned for working during a surge by an agent may be variable and based on factors such as the severity or intensity of the surge and whether or not the employee had to reschedule an appointment or break to work during the surge. The surge scores for agents may be used to incentivize agents to work during surge periods any may be considered when evaluating the agents for promotions, additional time-off, or other awards.

In an embodiment, a method is provided. The method includes: receiving a schedule, wherein a schedule comprises a plurality of periods, and identifications of agents of a plurality of agents assigned to each period of the plurality of periods; for each period of the plurality of periods, receiving a predicted workload for the period; based on the predicted workload for each period and the agents assigned to each period from the schedule, predicting a surge for at least one period of the plurality of periods; in response to the predicted surge for the at least one period, identifying at least one agent of the plurality of agents not assigned to the at least one period; and notifying the identified at least one agent of the predicted surge.

In an embodiment, a method is provided. The method includes: receiving workload statistics for a first plurality of periods; based on the received workload statistics for the first plurality of periods, predicting a surge for at least one period of a second plurality of periods; in response to predicting the surge for the at least one period of the second plurality of periods, requesting a confirmation of the surge for the at least one period; and if the confirmation is received: identifying at least one agent not assigned to work during the at least one period; and notifying the identified at least one agent of the predicted surge.

In an embodiment, a method is provided. The method includes: predicting a surge for a period; determining if a confidence value associated with the surge is greater than a confidence threshold; and if it is determined that the confidence value is greater than the confidence threshold: identifying an agent not scheduled to work during the period; and notifying the identified agent of the surge.

In an embodiment, a method is provided. The method includes: receiving an indication of a period, wherein the period is associated with a surge; determining at least one agent associated with the period; determining points for the determined at least one agent; and updating a surge score for the at least one agent based on the determined points.

The embodiments described herein solve many of the problems associated with surges described above. First, by predicting a surge before it occurs, additional employees or agents can be scheduled to work during the surge to either prevent or mitigate the surge. Second, by automatically identifying employees and agents who may be available to work during the surge and offering them incentives to work during the surge, an employer or administrator is released from the difficult task of finding available employees and agents and convincing them to work during a predicted surge.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an illustration of an example system architecture;

FIG. 2 is an illustration of an example system architecture for predicting and mitigating surge periods within the context of the environment of FIG. 1;

FIGS. 3-5 are illustrations of an example methods for predicting surge periods and for notifying one or more agents about the predicted surge periods;

FIG. 6 is an illustration of an example method for calculating a surge score for an agent; and

FIG. 7 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described within a cloud-based contact center, it will become evident to those skilled in the art that the implementations are not limited thereto.

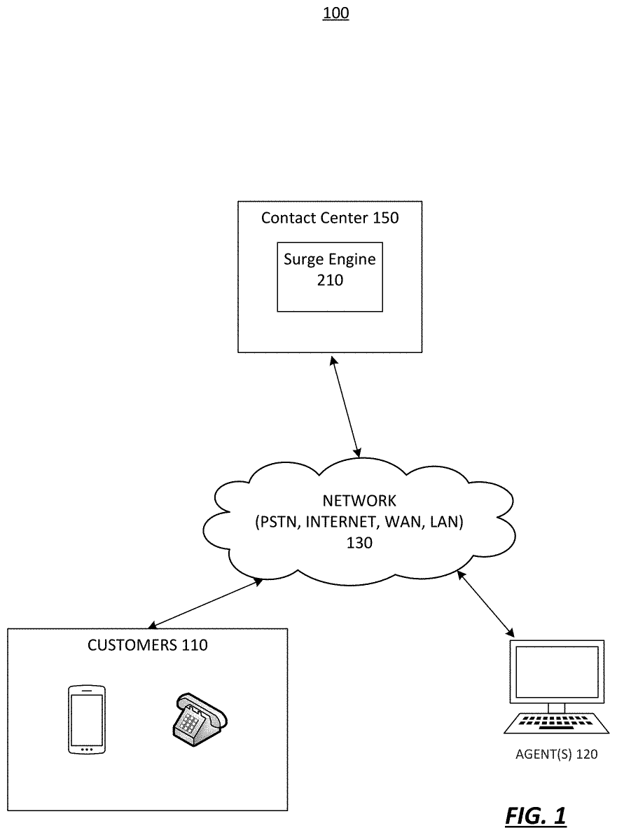

FIG. 1 is an example system architecture 100, and illustrates example components, functional capabilities and optional modules that may be included in a cloud-based contact center infrastructure solution. Customers 110 interact with a contact center 150 using voice, email, text, and web interfaces in order to communicate with agent(s) 120 through a network 130 and one or more of text or multimedia channels. The agent(s) 120 may be remote from the contact center 150 and handle communications with customers 110 on behalf of an enterprise. The agent(s) 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network. The network types are provided by way of example and are not intended to limit types of networks used for communications.

In some embodiments, agents 120 may be assigned to one or more queues, and the agents 120 assigned to a queue may handle communications that are placed in the queue by the contact center 150. For example, there may be queues associated with a language (e.g., English or Chinese), topic (e.g., technical support or billing), or a particular country of origin. When a communication is received by the contact center 150, the communication may be placed in a relevant queue, and one of the agents 120 associated to the relevant queue may handle the communication.

As described above, when the volume of customer 110 communications exceeds the number of agents 120 that are available to handle the communications, the contact center 150 may be experiencing what is referred to herein as a “surge”. Other definitions of a surge may be used. For example, in some embodiments, a surge may be defined as happening when a service level associated with the contact center 150 (or with a queue) falls below a threshold service level for a period of time. Other definitions of surge may be used.

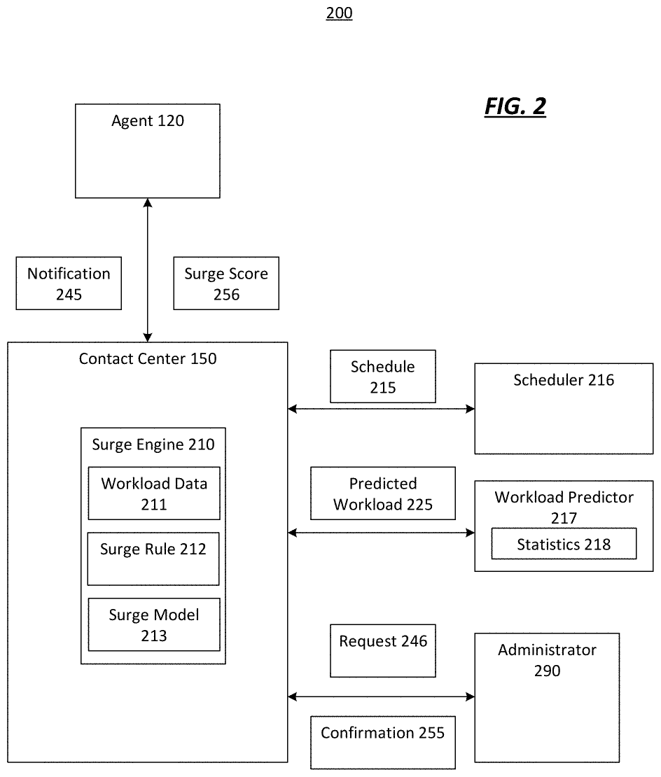

As will be described further below with respect to FIG. 2, to avoid surges, the contact center 150 may include a surge engine 210. The surge engine 210 may predict a time period when a surge is likely to occur at the contact center 150 based on historical workflow data associated with the contact center 150 and a schedule of the agents 120 that are assigned to work during the time period. When a surge is predicted, the surge engine 210 may further determine agents 120 that are not scheduled to work during the time period, but that may otherwise be available to work. The surge engine 210 can further provide incentives for the determined agents 120 to work during the time period associated with the predicted surge. As may be appreciated, the embodiments described herein are not limited to preventing surges in contact centers 150. In particular, the surge engine 210 may be used for any businesses or entity where employees (i.e., agents 120) interact with customers 110 either in-person, or via telephone or other electronic means. Examples of businesses or entities that may use the surge engine 210 include supermarkets (e.g., predict surges based on the number of shoppers in the store vs. the number of agents 120 working the checkout aisles), banks (e.g., predict surges based on the number of customers waiting in line vs. the number of agents 120 working as tellers), restaurants (e.g., predict surges based on number of customers waiting to eat vs. the number of agents 120 waiting tables or working in the kitchen), fulfillment centers (e.g., predict surges based on number of orders needing to fulfilled vs. the number of agents 120 working at the center), and claims processors (e.g., volume of claims received or pending vs. number of agents 120 working at the processor). Other businesses or entities may be included.

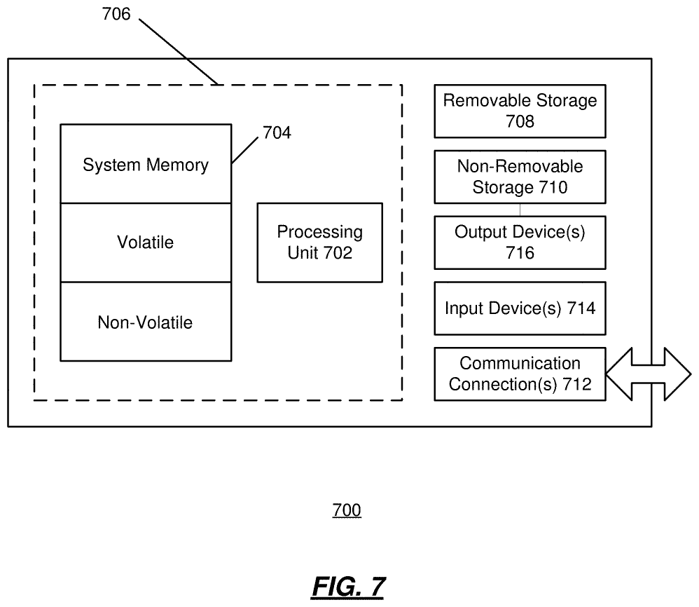

FIG. 2 is an illustration of an example system architecture for incorporating a surge engine 210 into a business or entity such as a contact center 150. As shown the surge engine 210 includes various modules and components such workload data 211, one or more surge rules 212, and one or more surge models 213. More or fewer modules or components may be supported by surge engine 210. The surge engine 210 may further interact with, or may receive data from, one or more of a scheduler 216, a workload predictor 217, and an administrator 290. Depending on the embodiment, each of the contact center 150, surge engine 210, scheduler 216, workload predictor 217, and administrator 290 may be implemented together or separately by one or more general purpose computing devices such as the computing system 700 illustrated with respect to FIG. 7.

The surge engine 210 may predict a surge for a period of a plurality of periods. The periods of the plurality of periods may each have the same time duration and may correspond to the smallest amount of time that can be scheduled in the contact center 150. For example, depending on the needs of the contact center 150, each time period may have a duration of fifteen minutes, thirty minutes, or one hour. Other time durations may be used.

As will be described in turn, the surge engine 210 may predict two types of surges. The first type of surge is referred to herein as a forecast surge and the second type of surge is referred to herein as an intraday surge. Other types of surges may be predicted. When the term surge is used in the present application and claims, it is may refer to one or both of forecast or intraday type surges. Depending on the embodiment, a surge may be predicted for an entire contact center 150 or may be predicted on a queue by queue basis.

Forecast surges may be surges that are predicted based on the historical workload of the contact center 150 or based on how busy the contact center 150 was in the past at or around the same time period. In some embodiments, the surge engine 210 may receive a predicted workload 225 for each period of a plurality of periods that the surge engine 210 is considering from the workload predictor 217. The surge engine 210 may provide the workload predictor 217 with an indicator of a period (e.g., a date and a time) and the workload predictor 217 may provide a predicted workload 225 for the identified period in response.

In one embodiment, the predicted workload 225 for a period may include a total number of communications that the contact center 150 is predicted to receive during the associated period. Where the surge engine 210 is part of a business such as a retail establishment, the predicted workload 225 may include a total number of customers that are predicted to visit the business during the associated period. Other information may be included in the predicted workload 225.

The workload predictor 217 may generate the predicted workload 225 based on statistics 218 collected by the workload predictor 217 for the contact center 150. The statistics 218 may be historical statistics 218 and may include identifiers of past periods and, for each past period, may include a measure of the actual workload experienced by the contact center 150. For example, for a period such as Nov. 2, 2018 3:00 pm-3:15 pm, the statistics 218 may indicate that twenty calls were received. Any method for generating a predicted workload 225 for a period based on historical workload statistics 218 about the period or similar periods may be used.

The surge engine 210 may predict a forecast surge for a period using the predicted workload 225 for the period and a schedule 215 for the period. The schedule 215 for a period may be received by the surge engine 210 from a scheduler 216. The schedule 215 for a period may identify the period and each agent 120 that is scheduled to work the identified period.

The surge engine 210 may predict a forecast surge for a period based on the predicted workload 225 for the period, the schedule 215 for the period, and one or more surge rules 212. A surge rule 212 may be a rule that can be applied by the surge engine 210 to the predicted workload 225 and the schedule 215 to predict a forecast surge for the time period (or for multiple time periods). The surge rule 212 may be set by an administrator 290, for example.

In some embodiments, the surge rule 212 may be based on an expected service level for a contact center 150 (or queue). The service level associated with a contact center 150 may specify a maximum wait time for customers of the contact center 150. The surge engine 210 may determine, based on the predicted workload 225 and schedule 215 for a period, whether the service level associated with the contact center 150 is likely to be satisfied. If the service level is not likely to be satisfied by more than a threshold amount, the surge engine 210 may predict a forecast surge for the period. As another example, the surge rule 212 may predict a surge when a number of agents 120 scheduled to work during a period falls below a number of agents 120 needed to work during the period to maintain the service level for the predicted workload 225 by more than a threshold number of agents 120. Other surge rules 212 may be supported.

In some implementations, the surge rule 212 applied by the surge engine 210 when predicting forecast surges, may be set by an administrator 290. For example, the administrator 290 may use a user-interface to create one or more surge rules 212.

Alternatively, or additionally, the surge engine 210 may learn the surge rules 212 based on feedback from the administrator 190 regarding predicted surges. For example, when the surge engine 210 predicts a forecast surge based on a surge rule 212, the surge engine 210 may send a request 246 to the administrator 290 to confirm the predicted surge. The request 246 may include information such as the number of extra agents 120 needed to prevent the service level from falling below the threshold service level and the predicted workload 225 that the predicted surge is based on.

After the administrator 290 receives the request 246, the administrator 255 may confirm the predicted surge (i.e., confirm that they want to add more agents 120 to the schedule 215 to prevent the surge), or reject the predicted surge (i.e., confirm that they do not want to add more agents 120 to the schedule 215). The confirmation (or rejection) may be sent to the surge engine 210 by the administrator 290 as the confirmation 255.

After receiving the confirmation 255, the surge engine 210 may update the surge rule 212. If the confirmation 255 is negative (i.e., rejects the predicted forecast surge), the surge engine 210 may update the surge rule 212 such that surge rule 212 is less likely to predict a forecast surge. For example, if the surge rule 212 was to predict a forecast surge when the predicted service level is less than 50% of a goal service level, the surge engine 210 may revise the surge rule 212 to predict a forecast surge when the predicted service level is less than 60% of the goal service level.

As another example, if the surge rule 212 was to predict a forecast surge when meeting the desired service level requires more than three additional agents 120, the surge engine 210 may revise the surge rule 212 to predict a forecast surge when meeting the desired service level requires more than four additional agents 120. In this way, the surge rule 212 is continuously updated to reflect administrator 290 preferences, but no explicit surge rule 212 creation by the administrator 290 is required. In addition, machine learning may be used to update or revise the surge rule 212 based on the confirmation 255.

As may be appreciated, because the surge engine 210 predicts forecast surges based on predicted workloads 225 and schedules 215, the surge engine 210 may predict forecast surges for periods well into the future. For example, the surge engine 210 may predict a forecast surge (or no forecast surge) for a period as soon as the schedule 215 is generated for a period by the schedule 216. Alternatively, or additionally, the surge engine 210 may predict a forecast surge (or no forecast surge) for a period in response to detecting a change to the associated schedule 215 (e.g., when one or more agents 120 are removed from the schedule 215).

When a forecast surge is predicted (and confirmed by the administrator 290), additional agents 120 can be requested to work during the period. The process for requesting new agents 120 to work will be discussed further below.

As described above, the second type of surge is known as an intraday surge. Unlike forecast surges, which may be predicted well in advance based on historical workload statistics 218, an intraday surge may be predicted for an upcoming period of a current day based on real-time workload data 211 for a current period and the predicted workload 225 for the current period as predicted by the workload predictor 217. The workload data 211 may include any information about the current workload of the contact center 150 (or queue) such as call or communication volume, a number of communications waiting to be routed to an agent 120, and average call times. Other information may be included.

The surge engine 210 may predict an intraday surge by comparing the predicted workload 225 for a current period with the workload data 211 for the current period and may predict an intraday surge based on the comparison. For example, if the current workload of the contact center 150 (or queue) as shown by the workload data 211 is much less than the predicted workload 225, the surge engine 210 may determine that an upcoming period is likely to experience an intraday surge to account for the discrepancies between the predicted and measured workloads.

Similarly, the surge engine 210 may use the workload data 211 and predicted workload 225 to cancel or downgrade a forecast surge. For example, if the current workload of the contact center 150 (or queue) as shown by the workload data 211 is much greater than the predicted workload 225, the surge engine 210 may determine that forecast surge predicted for an upcoming period is unlikely to occur.

In some embodiments, the surge engine 210 may predict an intraday surge for an upcoming period based on the workload data 211 for a current period, the predicted workload 225 for the current period, and a surge model 213. The surge model 213 may receive as an input the workload data 211 for a current period and the predicted workload 225 for the current period and may output the probability that an upcoming period may experience an intraday surge. The surge model 213 may have been trained to predict surges based on workload data 211 for previous periods and the predicted workload 225 for each previous period. Any method for training a model may be used.

In some embodiments, the intraday surge prediction for a period may further include a confidence. The surge engine 210 may generate a request 246 for the administrator to confirm an intraday surge when the confidence is less than a threshold confidence. Depending on the embodiment, whether the administrator approves the intraday surge may be used as feedback to further train the surge model 213, for example.

In some embodiments, a predicted surge (either intraday or forecast) may be associated with a predicted intensity. The intensity may be related to a number of factors such as the number of additional agents 120 that may be required to mitigate a surge, the length or duration of the surge, and an expected service level deviation due to the surge. Other factors may be considered. A surge with a high predicted intensity may be referred to herein as a high surge and a surge with a low predicted intensity may be referred to herein as a low surge. As another example, the surge engine 210 may assign an intensity score to the surge based on the predicted intensity.

After the surge engine 210 predicts a surge for a period (either intraday or forecast), and the predicted surge is approved or confirmed by the administrator 290, the surge engine 210 may attempt to mitigate the predicted surge by scheduling additional agents 120 to work during the period associated with the predicted surge.

Depending on the embodiment, the surge engine 210 may mitigate the surge by first determining agents 120 associated with the contact center 150 that are not already scheduled to work during the surge. For example, the surge engine 210 may use the schedule 215 associated with the period and may determine agents 120 of the contact center 150 that are not scheduled to work during the period.

Of the determined agents 120, the surge engine 210 may first identify those agents 120 who are also available to work during the period. In some implementations, the surge engine 210 may identify agents 120 who are working during periods that are close in time to the period associated with the surge. For example, the surge engine 210 may identify agents 120 who are working periods that are adjacent to the period associated with the surge.

In addition, the surge engine 210 may further identify those agents 120 who have the necessary skills to work during the period. For example, the predicted surge may be for a queue that requires the agents 120 to have particular skills such as speaking a particular language or having a particular technical proficiency. The particular skills associated with a queue may set by the administrator 290, for example.

In addition, the surge engine 210 may identify agents 120, who may not be available to work during the period due to a scheduling conflict but may consider changing their schedule 215 so that they could work during the periods associated with the surge. For example, the surge engine 210 may identify agents 120 with meetings or other scheduled activities that could be rescheduled so that the agents 120 could work during the period associated with the surge. In another example, the surge engine 210 may identify agents 120 who have a break scheduled during the period that could be moved to outside of the period.

In addition, the surge engine 210 may identify other employees, such as managers or supervisors, who could work as agents 120 during the surge. The surge engine 210 may identify other employees with the skills needed to work during the surge period. Similar to agents 120, the surge engine 210 may further identify other employees with the necessary skills that have scheduled meetings, appointments, or breaks during the surge period that could be rescheduled.

As may be appreciated, when the surge engine 210 identifies agents 120, or other employees, who could work during the period associated with the surge, the surge engine 210 may consider local laws or contact center 150 policies when identifying agents 120. For example, the surge engine 210 may ensure that an identified agent 120 would not exceed some threshold number of working hours or exceed some threshold amount of overtime hours by working the period associated with the surge. The relevant laws, rules, or policies for agent 120 working hours may be provided by the administrator 290.

After identifying the agents 120 who may be available to work during the period associated with the surge, the surge engine 210 may generate and send a notification 245 to each identified agent 120. The notification 245 may be an electronic notification 245 (e.g., email or SMS message) and may indicate the period associated with the surge. The notification 245 may further include a link or user interface element through which the agent 120 can either accept or decline the request to work during the period. If an agent 120 accepts the request to work during the period, the agents 120 may be added to the schedule 215 associated with the period.

In embodiments where some of the agents 120 have a conflict with the period associated with the surge (e.g., a scheduled meeting or a scheduled break), the notification 245 may indicate the conflict to the agent 120 and may even propose another time to have the scheduled meeting or break. For example, the surge engine 210 may look at the schedules 215 of all of the employees and agents 120 associated with the meeting and may propose a new time that works for all of the associated employees and agents 120. The notification 245 may further indicate to the agent 120 the importance of 100% adherence to the agent's schedule to help mitigate the surge.

In some embodiments, the notification 245 may further indicate a reward or bonus associated with accepting the request to work during the period associated with the surge. As will be discussed further below with respect to the surge score 256, the reward may be an amount of points that may be provided to the agent 120 upon working the period associated with the surge. These points may be used to calculate the surge score 256 for the agent 120.

The surge engine 210 may further maintain a surge score 256 for each agent 120 based on the agent 120 accepting requests to work during a period associated with a surge. In some embodiments, the amount of points added to the surge score 256 for an agent 120 for working a period may be fixed and set by an administrator 290. For example, the agent 120 may be allotted five points for working during a period associated with a surge. Other amounts of points may be allotted.

In other embodiments, the amount of points added to the surge score 256 for an agent 120 may be variable and may be dependent on a variety of factors set by the administrator 290. For example, an agent 120 may get more points depending on the intensity of the surge (e.g., high surge or low surge), the time or date associated with the period (e.g., a period falling at night or on a holiday may receive more points than a period falling on a regular date or time), the difficulty getting agents 120 to work during the period, whether the agent 120 rescheduled a meeting or break to work during the period, and whether or not the agent 120 adhered to the schedule 100%. Other factors may be considered.

In addition, the agents 120 may receive bonus points from the surge engine 210 for meeting some surge related milestones. For example, an agent 120 may receive ten points for working their first surge period or may receive a bonus fifteen points for working multiple surge periods in a row. These bonus points may be added to the surge scores 256 associated with the agents 120.

The calculated surge scores 256 may be used to incentivize agents 120 to volunteer to work during periods associated with surges. These incentives may include awards that are conditioned on achieving certain scores 256 or additional vacation or paid time off. The scores 256 may further be considered by the administrator 290 when conducting performance reviews or assessing agents 120 for promotions. In addition, the agents 120 may be allowed to display their scores 256 in an electronic profile associated with the contact center 150, for example. Any method or technique for incentivizing agents 120 to work during periods associated with surges may be used.

The surge engine 210 may further display or show predicted surge periods to one or more agents 120 or supervisors (e.g., administrators 290). The surge engine 210 may provide a graphical-user interface that displays one or more periods and points out which periods is associated with a predicted surge. Depending on the embodiment, each predicted surge may be displayed with information that indicates the intensity of the surge, and whether a enough agents 120 have volunteered to work during the period. The agents 120 may volunteer to work during one or more surge periods using the graphic user-interface, and the administrator 290 may confirm or reject predicted surges using the graphical-user interface.

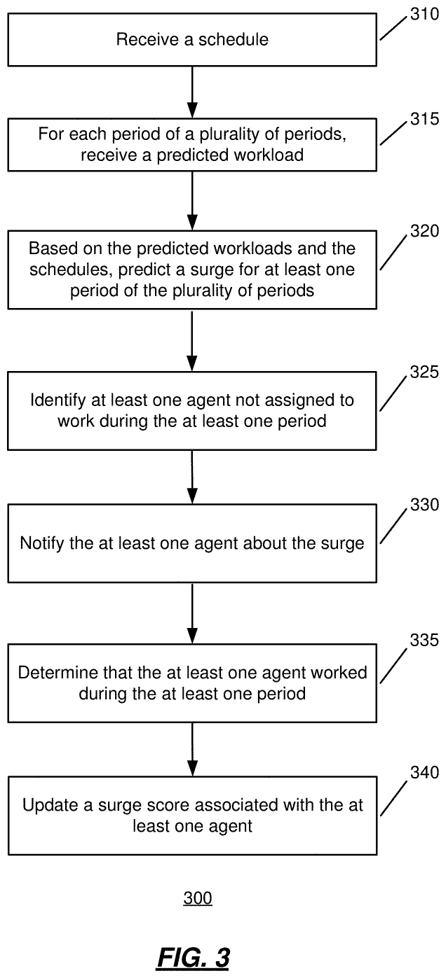

FIG. 3 is an illustration of an example method 300 for predicting one or more surges. The method 300 may be implemented by the surge engine 210 of the contact center 150.

At 310, a schedule is received. The schedule 215 may be received by the surge engine 210 from the scheduler 216. The schedule 215 may identify a plurality of periods and each period may indicate one or more agents 120 of a plurality of agents 120 that are assigned to work during the period. Each period may correspond to some amount of time such as five minutes, ten minutes, thirty minutes, etc.

At 315, for each period of the plurality of periods, a predicted workload is received. The predicted workload 225 may be received by a surge engine 210 from the workload predictor 217. The predicted workload 225 may be based on statistics 218, such as historical workloads, for the contact center 150, and may predict the number of customer 110 calls or communications that may be received by the customer center 150 for each period.

At 320, a surge is predicted for at least one period of the plurality of periods. The surge may be predicted by the surge engine 210 based on the predicted workloads 225 and the schedules 215 associated with each period. The predicted surge may be a forecast surge, for example.

In some embodiments, the surge engine 210 may predict a surge using one or more surge rules 212. For example, the surges rule 212 may predict a surge when one or more of the surge rules 212 are satisfied. The surge rules 212 may be based on a service level of the contact center 150 falling below a threshold service level, or the contact center 150 being deficient in more than a threshold number of agents 120 given the predicted workload 225. Other rules 212 may be supported.

At 325, at least one agent not assigned to work during the at least one period is identified. The at least one agent 120 may be identified by the contact center 150 using the schedule 215 associated with the period. In some embodiments, identifying the at least one agent may include one or more of identifying an agent 120 taking a break during the at least one period, identifying an agent 120 not scheduled during the at least one period, identifying an agent 120 scheduled to work a period other than the at least one period, and identifying an agent 120 scheduled for a meeting during the at least one period.

At 330, the at least one agent is notified of the predicted surge. The at least one agent 120 may be notified of the surge by the surge engine 210 sending a notification 245 to the at least one agent 120. The notification 245 may be an email, text, or telephone call, for example. The notification 245 may indicate the at least one period associated with the predicted surge.

At 335, a determination is made that the at least one agent worked during the at least one period. The determination may be made by the surge engine 210 based on the schedule 215.

At 340, a surge score associated with the at least one agent is updated. The surge score 256 associated with the at least one agent 120 may be updated by the surge engine 210 in response to determining that the at least one agent 120 worked during the at least one period.

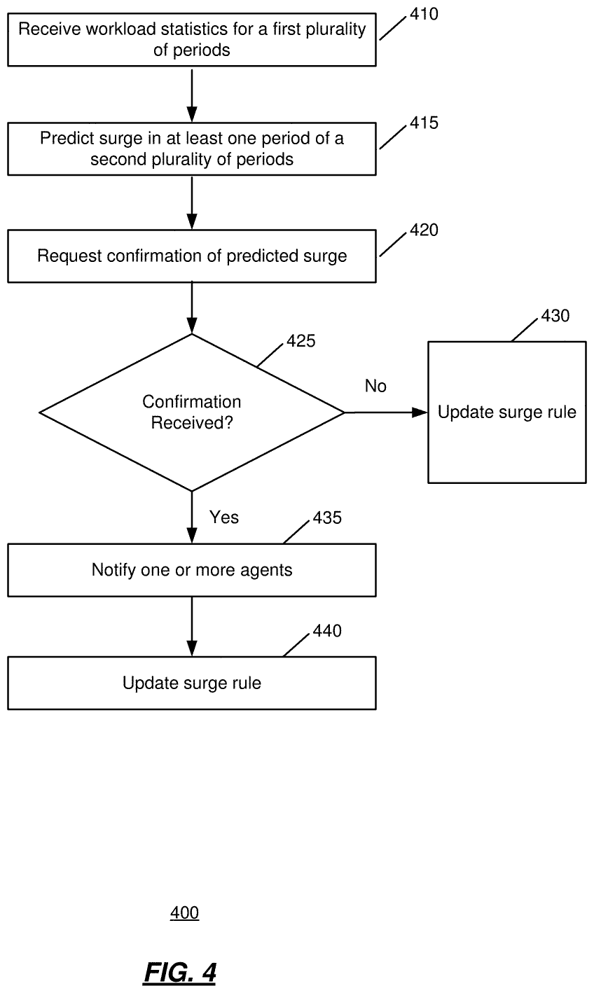

FIG. 4 is an illustration of an example method 400 for predicting one or more surges. The method 400 may be implemented by the surge engine 210 of the contact center 150.

At 410, workload statistics for a first plurality of periods is received. The workload statistics may be part of the workload data 211 and may be received by the surge engine 210. In some embodiments, the workload statistics may be statistics about the workload that the contact center 150 has been experiencing thus far during a current day. Accordingly, the first plurality of periods may be periods that have passed during the current day. The workload statistics may indicate the volume of calls received by the contact center 150 so far during the day.

At 415, a surge in at least one period of second plurality of periods is predicted. The surge may be an intraday surge and may be predicted by the surge engine 210 based on the workload statistics associated with the first plurality of periods and the predicted workloads 225 for the periods of the first plurality of periods and the second plurality of periods. The second plurality of periods may be future or upcoming periods of the current day.

For example, the surge engine 210 may determine, based on the workload statistics, that the contact center 150 was much less busy during the first plurality of periods (i.e., earlier in the day) than predicted by the predicted workloads 225. Accordingly, the surge engine 210 may determine that the contact center 150 is likely to be busier during at least one of the periods of the second plurality of periods (i.e., later in the day) than predicted. If the prediction satisfies one of more of the surge rules 212, then the surge engine 210 may predict a surge in a least one period of the second plurality of periods.

Alternatively, the surge engine 210 may predict the surge using a surge model 213.

At 420, confirmation of the predicted surge is requested. The surge engine 210 may request conformation by sending a request 246 to an administrator 290. The request 246 may ask that the administrator 290 confirm (or not confirm) the predicted surge.

At 425, a determination is made as to whether a confirmation was received. The determination may be made by the surge engine 210. If no confirmation 255 was received (or a negative confirmation 255 was received), then the method 400 may continue at 430. Else the method 400 may continue at 435.

At 430, the surge rule is updated. The surge rule 212 may be updated by the surge engine 210 in response to the administrator 290 not confirming the predicted surge. Accordingly, the surge engine 210 may tighten or make the surge rule 212 more restrictive. Where the surge was predicted using a surge model 213, the surge engine 210 may provide negative feedback to the surge model 213.

At 435, one or more agents are notified. The one or more agents 120 may be notified by the contact center 150 sending a notification 245 to each of the one or more agents. Because the administrator 290 approved the surge, the notification 245 may include a request for each of the one or more agents 120 to work during the at least one period to mitigate the predicted surge.

At 440, the surge rule is updated. The surge rule 212 may be updated by the surge engine 210 in response to the administrator 290 confirming the predicted surge. For example, the surge engine 210 may loosen the surge rule 212 or may make the surge rule 212 less restrictive. Where the surge was predicted using a surge model 213, the surge engine 210 may provide positive feedback to the surge model 213.

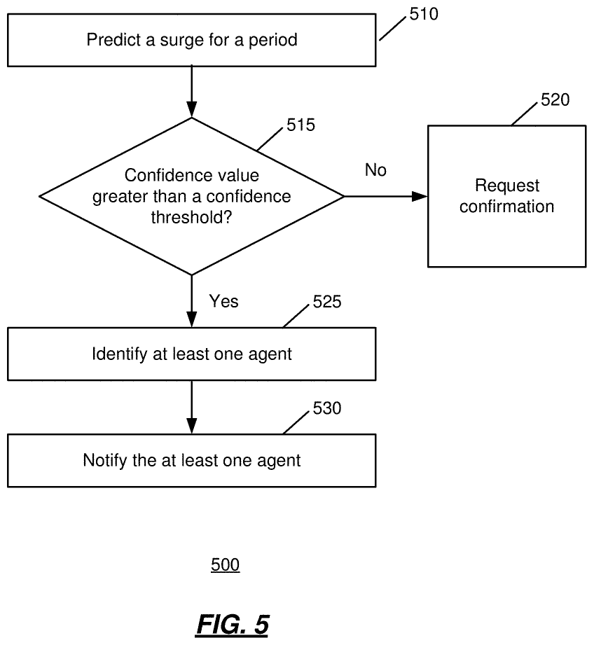

FIG. 5 is an illustration of an example method 500 for predicting one or more surges. The method 500 may be implemented by the surge engine 210 of the contact center 150.

At 510, a surge is predicted for a period. The surge may be predicted by the surge engine 210. The period may be a time period of a plurality of time periods. The surge may be an intraday surge and may have been generated by the surge engine 210 using a surge model 213, a predicted workload 225 for the period, and current workload statistics for the contact center 150.

At 515, a determination is made as to whether a confidence value is greater than a threshold confidence. The determination may be made by the surge engine 210. The confidence value may have been generated by the surge model 213 for the generated surge prediction. The greater the confidence value the greater the likelihood that the predicted sure is correct. The threshold confidence value may be set by the administrator 290. If the confidence value is less than the confidence threshold, the method 500 may continue at 525. Else, the method 500 may continue at 520.

At 520, confirmation is requested. The confirmation of the predicted surge may be requested by the surge engine 210 from the administrator 290 by sending a request 246. Because the confidence vale of the predicted surge was below the confidence threshold, the predicted surge may be confirmed by the administrator 290 before any actions are taken by the surge engine 210 (e.g., request agents 120 to work during the associated period).

At 525, at least one agent not assigned to work during the period associated with the surge is identified. The agent 120 may be identified by the contact center 150 using the schedule 215 associated with the period.

At 530, the agent is notified of the predicted surge. The agent 120 may be notified of the surge by the surge engine 210 sending a notification 245 to the agent 120. The notification 245 may be an email, text, or telephone call, for example. The notification 245 may indicate the period associated with the predicted surge.

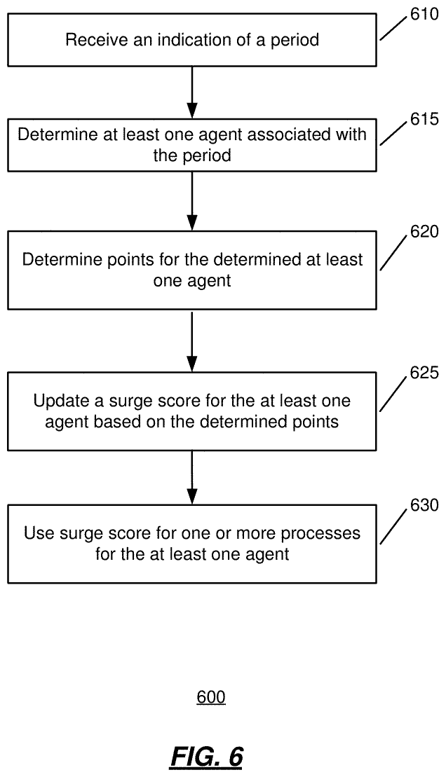

FIG. 6 is an illustration of an example method 600 for calculating a surge score. The method 600 may be implemented by the surge engine 210 of the contact center 150.

At 610, an indication of a period is received. The indication may be received by the surge engine 210. The period may be a time period that was predicted to have a surge by the surge engine 210.

At 615, at least one agent associated with the period is determined. The at least one agent 120 may be determined by the surge engine 210. The at least one agent 120 may be an agent 120 that worked at the contact center 150 (or other entity) during the period. Depending on the embodiment, the surge engine 210 may determine the at least one agent 120 from a schedule 215 associated with the period.

At 620, points for the at least one agent are determined. The points may be determined by the surge engine 210. The point determined for the at least one agent 120 may be a reward for working during a period that was either associated with, or predicted to have, a surge.

The surge engine 210 may determine the points for the at least one agent 120 based on a variety of factors. These factors may include the severity or intensity of the surge (e.g., was the surge a low surge or a high surge), whether or not the agent 120 had to reschedule any breaks or meetings to work during the surge, and whether or not the agent 120 was fully compliant with a schedule 215 during the period. Other factors may be included. The factors, and their respective points, may be set by the administrator 290.

At 625, a surge score associated with the at least one agent is updated based on the determined points. The surge score 256 may be updated by the surge engine 210. Depending on the embodiment, the surge engine 210 may update the surge score 256 by adding the determined points to the surge score 256 associated with the at least one agent 120.

At 630, the surge score is used for one or more processes for the at least one agent. The surge score 256 may be used by the surge engine 210 for processes such as evaluating or reviewing the at least one agent 120, determining whether or not to promote the at least one agent 120, determining additional time-off or vacation for the at least one agent 120, and determining an award for the at least one agent 120. Other incentives may be used.

FIG. 7 shows an exemplary computing environment in which example embodiments and aspects may be implemented. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 7, an exemplary system for implementing aspects described herein includes a computing device, such as computing device 700. In its most basic configuration, computing device 700 typically includes at least one processing unit 702 and memory 704. Depending on the exact configuration and type of computing device, memory 704 may be volatile (such as random access memory (RAM)), non-volatile (such as read-only memory (ROM), flash memory, etc.), or some combination of the two. This most basic configuration is illustrated in FIG. 7 by dashed line 706.

Computing device 700 may have additional features/functionality. For example, computing device 700 may include additional storage (removable and/or non-removable) including, but not limited to, magnetic or optical disks or tape. Such additional storage is illustrated in FIG. 7 by removable storage 708 and non-removable storage 710.

Computing device 700 typically includes a variety of tangible computer readable media. Computer readable media can be any available tangible media that can be accessed by device 700 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 704, removable storage 708, and non-removable storage 710 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

Computing device 700 may contain communications connection(s) 712 that allow the device to communicate with other devices. Computing device 700 may also have input device(s) 714 such as a keyboard, mouse, pen, voice input device, touch input device, etc. Output device(s) 716 such as a display, speakers, printer, etc. may also be included. All these devices are well known in the art and need not be discussed at length here.

Returning to FIG. 1, agent(s) 120 and customers 110 may communicate with each other and with other services over the network 130. For example, a customer calling on telephone handset may connect through the PSTN and terminate on a private branch exchange (PBX). A video call originating from a tablet may connect through the network 130 terminate on the media server. A smartphone may connect via the WAN and terminate on an interactive voice response (IVR)/intelligent virtual agent (IVA) components. IVR are self-service voice tools that automate the handling of incoming and outgoing calls. Advanced IVRs use speech recognition technology to enable customers to interact with them by speaking instead of pushing buttons on their phones. IVR applications may be used to collect data, schedule callbacks and transfer calls to live agents. IVA systems are more advanced and utilize artificial intelligence (AI), machine learning (ML), advanced speech technologies (e.g., natural language understanding (NLU)/natural language processing (NLP)/natural language generation (NLG)) to simulate live and unstructured cognitive conversations for voice, text and digital interactions. In yet another example, Social media, email, SMS/MMS, IM may communicate with their counterpart's application (not shown) within the contact center 150.

The contact center 150 itself be in a single location or may be cloud-based and distributed over a plurality of locations. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The ACD is used by inbound, outbound and blended contact centers to manage the flow of interactions by routing and queuing them to the most appropriate agent. Within the CTI, software connects the ACD to a servicing application (e.g., customer service, CRM, sales, collections, etc.), and looks up or records information about the caller. CTI may display a customer's account information on the agent desktop when an interaction is delivered. Campaign management may be performed by an application to design, schedule, execute and manage outbound campaigns. Campaign management systems are also used to analyze campaign effectiveness.

For inbound SIP messages, the routing server may use statistical data from reporting/dashboard information and a routing database to the route SIP request message. A response may be sent to the media server directing it to route the interaction to a target agent 120. The routing database may include: customer relationship management (CRM) data; data pertaining to one or more social networks (including, but not limited to network graphs capturing social relationships within relevant social networks, or media updates made by members of relevant social networks); agent skills data; data extracted from third party data sources including cloud-based data sources such as CRM; or any other data that may be useful in making routing decisions.

The integration of real-time and non-real-time communication services may be performed by unified communications (UC)/presence sever. Real-time communication services include Internet Protocol (IP) telephony, call control, instant messaging (IM)/chat, presence information, real-time video and data sharing. Non-real-time applications include voicemail, email, SMS and fax services. The communications services are delivered over a variety of communications devices, including IP phones, personal computers (PCs), smartphones and tablets. Presence provides real-time status information about the availability of each person in the network, as well as their preferred method of communication (e.g., phone, email, chat and video).

Recording applications may be used to capture and play back audio and screen interactions between customers and agents. Recording systems should capture everything that happens during interactions and what agents do on their desktops. Surveying tools may provide the ability to create and deploy post-interaction customer feedback surveys in voice and digital channels. Typically, the IVR/IVA development environment is leveraged for survey development and deployment rules. Reporting/dashboards are tools used to track and manage the performance of agents, teams, departments, systems and processes within the contact center. Reports are presented in narrative, graphical or tabular formats. Reports can be created on a historical or real-time basis, depending on the data collected by the contact center applications. Dashboards typically include widgets, gadgets, gauges, meters, switches, charts and graphs that allow role-based monitoring of agent, queue and contact center performance. Unified messaging (UM) applications include various messaging and communications media (voicemail, email, SMS, fax, video, etc.) stored in a common repository and accessed by users via multiple devices through a single unified interface.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a schedule, wherein a schedule comprises a plurality of periods, and identifications of agents of a plurality of agents assigned to each period of the plurality of periods;
for each period of the plurality of periods, receiving a predicted workload for the period;
based on the predicted workload for each period and the agents assigned to each period from the schedule, predicting a surge for at least one period of the plurality of periods;
in response to the predicted surge for the at least one period, identifying at least one agent of the plurality of agents not assigned to the at least one period; and
notifying the identified at least one agent of the predicted surge.

2. The method of claim 1, further comprising:
determining that the at least one agent worked during the at least one period; and
in response to the determination, updating a surge score associated with the at least one agent.

3. The method of claim 1, wherein predicting the surge for at least one period of the plurality of periods comprises:
determining that a surge rule is satisfied for the at least one period; and
in response to determining that the surge rule is satisfied, predicting the surge for the at least one period.

4. The method of claim 1, further comprising:
in response to predicting the surge for the at least one period, requesting a confirmation of the surge for the at least one period;
receiving a confirmation of the surge for the at least one period;
notifying the identified at least one agent of the predicted surge in response to receiving the confirmation; and
updating a surge rule in response to receiving the confirmation.

5. The method of claim 1, further comprising:
in response to predicting the surge for the at least one period, requesting a confirmation of the surge for the at least one period;
receiving a negative confirmation of the of the surge for the at least one period; and
updating a surge rule in response to receiving no confirmation.

6. The method of claim 1, wherein identifying at least one agent of the plurality of agents not assigned to the at least one period comprises one or more of identifying an agent taking a break during the at least one period, identifying an agent not scheduled to work during the at least one period, identifying an agent scheduled to work during a period other than the at least one period, and identifying an agent scheduled for a meeting during the at least one period.

7. The method of claim 1, wherein notifying the at least one agent comprises one or more of emailing the at least one agent, texting the at least one agent, or calling the at least one agent.

8. A non-transitory computer-readable medium comprising instructions that, when executed by at least one processor, cause a computer system to:
receive a schedule, wherein a schedule comprises a plurality of periods, and identifications of agents of a plurality of agents assigned to each period of the plurality of periods;
for each period of the plurality of periods, receive a predicted workload for the period;
based on the predicted workload for each period and the agents assigned to each period from the schedule, predict a surge for at least one period of the plurality of periods;
in response to the predicted surge for the at least one period, identify at least one agent of the plurality of agents not assigned to the at least one period; and
notify the identified at least one agent of the predicted surge.

9. The computer-readable medium of claim 8, further comprising instructions that, when executed by the at least one processor, cause the computer system to:
determine that the at least one agent worked during the at least one period; and
in response to the determination, update a surge score associated with the at least one agent.

10. The computer-readable medium of claim 8, wherein predicting the surge for at least one period of the plurality of periods comprises:
determine that a surge rule is satisfied for the at least one period; and
in response to determining that the surge rule is satisfied, predict the surge for the at least one period.

11. The computer-readable medium of claim 8, further comprising instructions that, when executed by the at least one processor, cause the computer system to:
in response to predicting the surge for the at least one period, request a confirmation of the surge for the at least one period;
receive a confirmation of the surge for the at least one period;
notify the identified at least one agent of the predicted surge in response to receiving the confirmation; and
update a surge rule in response to receiving the confirmation.

12. The computer-readable medium of claim 8, further comprising instructions that, when executed by the at least one processor, cause the computer system to:
in response to predicting the surge for the at least one period, request a confirmation of the surge for the at least one period;
receive a negative confirmation of the of the surge for the at least one period; and
update a surge rule in response to receiving no confirmation.

13. The computer-readable medium of claim 8, wherein identifying at least one agent of the plurality of agents not assigned to the at least one period comprises one or more of identifying an agent taking a break during the at least one period, identifying an agent not scheduled to work during the at least one period, identifying an agent scheduled to work during a period other than the at least one period, and identifying an agent scheduled for a meeting during the at least one period.

14. The computer-readable medium of claim 8, wherein notifying the at least one agent comprises one or more of emailing the at least one agent, texting the at least one agent, or calling the at least one agent.

15. A system comprising:
at least one processor; and
a non-transitory computer readable medium comprising instructions that, when executed by the at least one processor, cause the system to:
receive a schedule, wherein a schedule comprises a plurality of periods, and identifications of agents of a plurality of agents assigned to each period of the plurality of periods;
for each period of the plurality of periods, receive a predicted workload for the period;
based on the predicted workload for each period and the agents assigned to each period from the schedule, predict a surge for at least one period of the plurality of periods;
in response to the predicted surge for the at least one period, identify at least one agent of the plurality of agents not assigned to the at least one period; and
notify the identified at least one agent of the predicted surge.

16. The system of claim 15, further comprising instructions that, when executed by the at least one processor, cause the system to:
determine that the at least one agent worked during the at least one period; and
in response to the determination, update a surge score associated with the at least one agent.

17. The system of claim 15, wherein predicting the surge for at least one period of the plurality of periods comprises:
determine that a surge rule is satisfied for the at least one period; and
in response to determining that the surge rule is satisfied, predict the surge for the at least one period.

18. The system of claim 15, further comprising instructions that, when executed by the at least one processor, cause the system to:
in response to predicting the surge for the at least one period, request a confirmation of the surge for the at least one period;
receive a confirmation of the surge for the at least one period;
notify the identified at least one agent of the predicted surge in response to receiving the confirmation; and
update a surge rule in response to receiving the confirmation.

19. The system of claim 15, further comprising instructions that, when executed by the at least one processor, cause the system to:
in response to predicting the surge for the at least one period, request a confirmation of the surge for the at least one period;
receive a negative confirmation of the of the surge for the at least one period; and
update a surge rule in response to receiving no confirmation.

20. The system of claim 15, wherein identifying at least one agent of the plurality of agents not assigned to the at least one period comprises one or more of identifying an agent taking a break during the at least one period, identifying an agent not scheduled to work during the at least one period, identifying an agent scheduled to work during a period other than the at least one period, and identifying an agent scheduled for a meeting during the at least one period.
